(19) United States
(12) Patent Application Publication
(10) Pub. No.: US 2006/0032953 A1
(43) Pub. Date: Feb. 16, 2006

(54) Hydraulic opposed jet mill

(76) Inventor: George Kruse, Rapid City, SD (US)

Correspondence Address: Gene R. Woodle, 3516 Woodle Drive, Rapid City, SD, 57702, US

(21) Appl. No.: 11/198,658

(22) Filed: Aug. 5, 2005

Related U.S. Application Data
(60) Provisional application No. 60/602,029, filed on Aug. 16, 2004.

(51) Int. Cl. B02C 21/00

(52) U.S. Cl. 241/40

(57) ABSTRACT

Embodiments of an hydraulic opposed jet mill are disclosed which may be used to crush various minerals, including mica, or other materials to sub-micron size. At least one positive displacement pump forces an incompressible liquid, such as water, through a pair of opposed jets such that the two streams of water collide between the jets. A slurry of an incompressible liquid, such as water, and the mineral to be crushed is introduced into the jets at a point near the outlet end of the jets. The entrained mineral particles are forced out of the jets with great energy which causes multiple collisions and pulverization. In a second embodiment of the instant invention the slurry strikes an impingement plate rather than an opposed slurry stream.

### RELATED APPLICATIONS

This application relies for priority upon the Provisional Patent Application filed by George Kruse entitled Hydraulic opposed jet mill, Ser. No. 60/602,029, filed Aug. 16, 2004.

### BACKGROUND OF THE INVENTION

1. Field of the Invention

The present invention relates generally to the milling of minerals and more specifically to milling by shooting opposed jets of mineral and a carrying medium into one another.

2. Background Information

For hundreds of years, mankind has struggled to develop methods of reducing the size of ore and other minerals. Dozens of different types of mills have been invented to crush or mill minerals. In a hammer mill, for example, a series of “hammers” literally pound the material to crush it to a smaller size. Most often, after milling, the material is sized usually using one or more screens. Material which passes through a screen having the appropriate mesh size is usually sold or used in a manufacturing process, while material which doesn't pass through the appropriate screen is too large and is sent back to the mill.

In recent years, there has been increased interest in milling certain minerals to a very small size, usually referred to as nano sized particles. Generally, a nano particle is less than one micron. One potentially important use of nano particles is the creation of nano composite materials which have many desirable properties including high strength and light weight. One example of a nano composite would be the introduction of nano sized fillers into composite polymer structures. Nano particles are preferred over larger particles for such composites because they have a much greater surface area per weight than larger particles of the same material. The polymer has a much greater surface area to bond with when nano sized particles are used. For example, nano sized mica powder has approximately ten times as much surface area per gram as 75 micron sized mica powder.

Mica has several properties which make it very desirable for use in nano composites. One of the most important of which is the high aspect ratio of the material. That is, mica generally is in the shape of a flake and has a “diameter” which is significantly greater than its thickness. Aspect ratio may be defined as the ratio of the length or mean diameter to the thickness. When used as a filler or “strengthener,” materials having a high aspect ratio are generally preferable to materials having a low aspect ratio. As a rough analogy, concrete with a rebar filler (a high aspect ratio) is much stronger than concrete having an equal weight of steel balls as a filler (a low aspect ratio).

As a consequence of all of the above, more efficient and effective methods of milling minerals and other materials to nano size are in great demand. In addition, there is great interest in a method of milling materials such as mica which have a high aspect ratio to nano size while retaining the high aspect ratio. Under the current state of the art, mica, for instance, may be milled to nano size in an inefficient and expensive process, but when pulverized the mica assumes a shape more like a ball or cube than a flake with a high aspect ratio. A few minerals, such as mica, occur in the form of a plurality of very thin layers. The key to milling mica, for instance, to nano size, is to split the layers apart rather than breaking the layers in two.

One of the most promising possible avenues for successfully milling minerals and similar materials to a nano size involves the use of a jet mill. Jet mills are well known in the prior art as is demonstrated by the patents to Work (U.S. Pat. No. 2,846,250; Aug. 5, 1958) and Muschelknautz et al. (U.S. Pat. No. 3,876,156; Apr. 8, 1975). In Work the material to be pulverized is mixed with a vaporizable liquid such as water to form a slurry. The slurry is separated into two equal streams which pass through a heater to heat the slurry to a temperature and pressure such that part way through the heater a relatively low velocity dispersion of solid particles in a gas if formed. The two streams are then discharged into a “disintegrator chamber” such that the two streams flow through a pair of opposed nozzles and collide with each other. The collision is sufficient to mill the material. In Muschelknautz et al. a gas is forced through a gas propellant pipe and then over and under a stock container such that material in the stock container mixes with the gas and both pass through a jet tube. The material and the gas strike an impact plate where the material is pulverized.

Both the above patents and other known jet mill prior art use gas streams for pulverization. High pressure streams of liquid/material slurries are extremely abrasive and cause great wear on delivery tubes and nozzles.

The instant invention, a hydraulic opposed jet mill, is believed to solve, in a unique and effective manner, a variety of problems relating to the milling of minerals or other materials to very small sizes while maintaining the aspect ratio of the mineral or material.

The ideal hydraulic opposed jet mill should be capable of milling minerals or other materials to nano size. The ideal hydraulic opposed jet mill should also provide a method which greatly reduces abrasion wear on pumps, pipes, nozzles (or venturis) and other elements. The ideal hydraulic opposed jet mill also should insure that particles which have a high aspect ratio before milling should retain a high aspect ratio after milling or even cause the aspect ratio to be higher after milling. The ideal hydraulic opposed jet mill should also be simple, inexpensive, rugged, and easy to use.

### SUMMARY OF THE INVENTION

The hydraulic jet mill of the instant invention is a process which ends at a pair of opposed jets or venturis through which a mineral/water slurry is forced such that the minerals collide with sufficient energy to pulverize the mineral. In the following example, the mineral, mica, is used; but the process could be used to mill a variety of minerals and other materials. Although much of the following describes milling using opposed jet mills, another embodiment of the invention is one or more jets which are not opposed, but in which the mineral/water slurry strikes an impact or impingement plate rather than a stream from an opposed jet to cause pulverization.

The process begins with the introduction of mica particles which have been reduced to a greater than nano size using some conventional milling process into a incompressible liquid such as water. The slurry is separated into two roughly equal streams and pumped at low pressure and velocity to the forward portions of each of the two jets.

A conventional positive displacement pump pumps water or other incompressible liquid into a water line at low velocity. The water line splits into two self equalizing low velocity lines and the water is introduced into the rearward portion of each of the two jets. The cross sectional area of the rearward portion of the jets is significantly greater than the cross sectional area of the forward portion of the jets. This causes the velocity of the water or other incompressible liquid to increase.

The high velocity water sprays out of the jets. Because the cross sectional area of the jets grows smaller from the rearward portion to the forward portion, the pressure of the water near the forward portion of the jets becomes sufficiently small that the relatively low pressure mineral/water slurry enters the interior of the jet and mixes with the water within the jet. The shape of the opening of the jet tends to cause the mica particles to align such that they leave the opening of the jet edge forward rather than flat side forward. Mica particles collide, edge to edge, with high energy where the jets come together in a pulverization chamber. Because the particles are align edge forward, the collisions tend to cause the layers of mica to split apart as well as being broken in two. This helps to preserve the high aspect ratio of the mica particles. The openings in the forward ends of the jets are not only opposed, but are also coplanar.

The pulverization chamber is of sufficient size that the internal pressure is near ambient pressure. The milled mica slurry is drawn from the pulverization chamber and transported to a conventional centrifuge for de-watering. The majority of the water is separated from the milled mica and recycled to both the low pressure slurry line and the water line. The “cake” or damp milled mica is transported to a conventional dryer and then to a conventional air classifier for sorting of the material by particle size. The separated nano sized particles may be packaged and shipped as desired. The macro sized particles may be packaged and shipped or reintroduced to the slurry stream.

One of the major objects of the hydraulic opposed jet mill of the instant invention is to mill minerals or other materials to nano size.

Another objective of the present invention is to provide a method which greatly reduces abrasion wear on pumps, pipes, nozzles (or venturis) and other elements.

Another objective of the present invention is to insure that particles which have a high aspect ratio before milling should retain a high aspect ratio after milling.

Another objective of the present invention is to provide a milling process which is simple, inexpensive, rugged, and easy to use.

These and other features of the invention will become apparent when taken in consideration with the following detailed description and the drawings.

### BRIEF DESCRIPTION OF THE DRAWINGS

FIG. 1 is a schematic drawing of the hydraulic jet mill process of the instant invention;

FIG. 2 is a side view of one of the jets of the instant invention; and

FIG. 3 is a sectional view of one of the jets of the instant invention taken along line 3-3 of FIG. 2.

### DESCRIPTION OF A PREFERRED EMBODIMENT

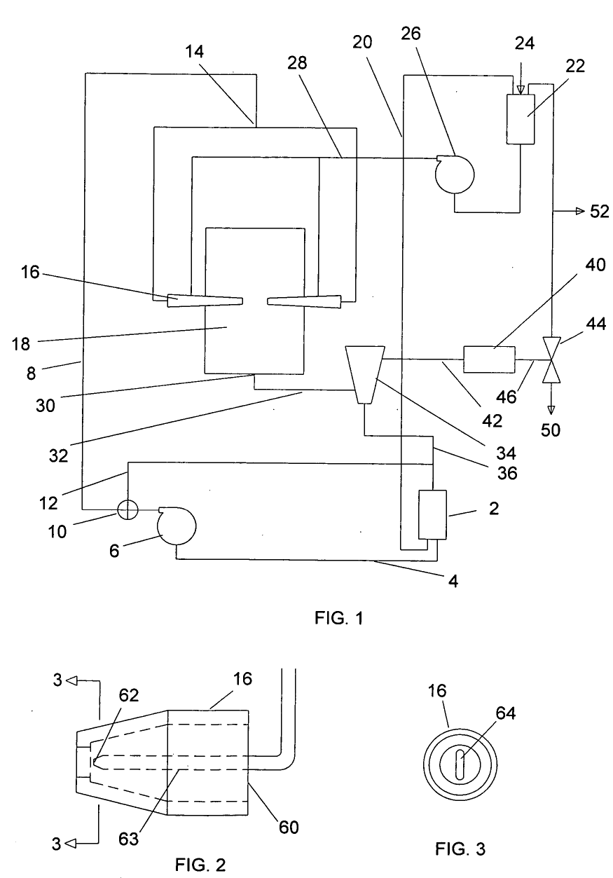

Referring to the drawings, FIGS. 1, 2 and 3, there is shown a preferred form of the hydraulic opposed jet mill of the instant invention. In the following description, mica is used to illustrate the invention, but the mill would work equally well with other minerals or materials. Water is used in the following description, but other incompressible fluids could be used if desired. The following describes an hydraulic opposed jet mill; but, in a second embodiment, rather than having opposed jets, the mill would employ one or more jets which were not opposed, but directed toward an impact or impingement plate.

Now referring to FIG. 1, a schematic drawing of the hydraulic jet mill process of the instant invention is shown. A water supply tank 2 is connected to a water supply line 4. A positive displacement pump 6 pumps water at from 6 to 500 gallons per minute from the water supply tank 2 into a low velocity water line 8. Although the above flow rate range was found to include optimum flow rate, a pump which produced significantly lower flow rates could be used provided the velocity of the slurry was sufficient to cause pulverization. A pressure regulator 10 in the low velocity water line 8 regulates the pressure in said low velocity water line 8 with any water necessary to regulate flow rate removed back to said water supply tank 2 through a water return 12. The low velocity water stream is split at 14 such that two relatively equal streams flow into the rearward portions of a pair of jets 16 which are mounted in a pulverization chamber 18. The jets 16 are mounted opposite one another such that the two high velocity streams of water from said high pressure water line 8 collide in the middle of the pulverization chamber 18.

Still referring to FIG. 1, a low pressure water line 20 also is connected to said water supply tank 2 and water flows through this line to a mixing tank 22. Preprocessed mica is also introduced into the mixing tank 22 at 24. The preprocessed mica would have been reduced in size to less than seventy-five microns. Water from the low pressure water line 20 is mixed with the mica within said mixing tank 22 in a conventional manner to create a slurry. The slurry is pumped by a low pressure pump 26 through a low pressure slurry line 28 (less than 300 psi) to the forward portion of each of said jets 16. The slurry mixes with the low velocity water and is sprayed out of said jets 16 at high velocity. Particles from the opposed jets 16 collide at high velocity and energy and these high energy collisions cause the particles to be pulverized and delaminated. (Minerals, such as mica, occur in nature as a plurality of thin sheets which may be though of as being laminated together.) Although said jets 16 are opposed and directed toward one another, particles may be pulverized with nearly as great efficiency if said jets 16 were directed toward a point within said pulverization chamber 18 which was between said jets 16, but not in a direct line with either of said jets 16. This would prevent abrasion from the high velocity particles from one of said jets 16 striking the other of said jets 16. Said jets 16 are configured such that they may be moved closer together or further apart. The pressure within said pulverization chamber 18 is maintained at or slightly above ambient pressure. Mica is generally considered to be nonabrasive. Although mica is used in the above example, in actual practice abrasive materials would be introduced at 24. Nonabrasive materials would be introduced at said water supply tank 2.

Still referring to FIG. 1, the slurry within said pulverization chamber 18, including additional water from said high pressure water line 8, with particles of greatly reduced size is extracted from said pulverization chamber 18 at 30 and transported through a de-watering line 32 to a conventional centrifuge 34, where most of the water is removed from the processed particles. This water is recycled to said water supply tank 2 through a water return line 36. The processed damp cake of particles is transferred to a conventional dryer 40 through a processed particle line 42. After drying, the processed particles are transported to a classifier 44 through a classifier line 46. There are several conventional classifiers available suitable for this purpose. A pigment grade, air classifier is preferred. After the dried particles have been classified in the classifier 44, nano sized particles are removed at 50. Larger particles may be removed at 52 or recycled to said mixing tank 22.

Now referring to FIG. 2, a side view of one of said jets 16 on the instant invention is shown. The low velocity water enters said jet 16 at the rear of said jet 16 as indicated at 60. The low pressure slurry is introduced near the forward portion of said jet 16 as indicated at 62 through a venturi tube 63. The venturi tube 63 is introduced through the rear of said jets 16 with the outlet near the forward portion of said jet 16. Because the cross sectional area of said jet 16 is relatively large at 60 compared to the cross sectional area at 62; the velocity of the fluid at 60 is relatively low and the static pressure is relatively high. At 62, the velocity is relatively high and the static pressure sufficiently reduced, that the low pressure slurry may enter said jet 16 at 62. This greatly reduces the abrasion of the particles on the various elements of the hydraulic opposed jet mill, because the particles are moving at high velocity only from 62 to the tip of said jet 16.

Now referring to FIG. 3, a cross sectional view of said jet 16 taken along line 3-3 of FIG. 2 is shown. The interior opening of said jet 16 has a round cross section at the rearward portion and gradually changes to the oval or slot shape at the orifice 64. Because of the shape of the orifice 64, it is believed that, when particles have a flake shape like mica, they will tend to be aligned edge forward rather than side forward when they pass through said orifice 64. Therefore, when the particles collide after passing through the opposed jets 18, they will tend to hit edge to edge. This caused the layers of a material such as mica to separate. Thus, as such particles collide and are pulverized, they tend to maintain their high aspect ratio rather than become round or more cubic in shape.

In a second embodiment, all elements are the same as described above; but rather than having opposed jets, one or more jets 16 would direct the mineral/water slurry against an impact or impingement plate (not shown) located within said pulverization chamber 18. Extensive testing of the operation and efficiency of the instant invention of this second embodiment have been done. Prior to treatment, ninety percent of the input mica was between 7 and 80 microns with a fairly even distribution of sizes between those limits. In these tests, the mica/water slurry was cycled through the process fifteen times before samples were taken and measurements made. The results of these tests are summarized in the following table.

Jet Openning Size (inches)

| | .041 | .021 | .015 | .011 |
|---|---|---|---|---|
| Velocity (M/s) | 18.6 | 71 | 139.2 | 253.3 |
| % Micron or less | 16 | 22 | 34 | 40 |

The average aspect ratio of the mica prior to treatment was 10 to 1. The aspect ratio of the mica after treatment varied from 30 to 1 to 40 to 1.

In a third embodiment, the centrifuge 34 is replaced by a conventional wet filter. With this wet filter the slurry is pressed through the filter and the slurry can be separated into slurry with nano sized particles and slurry with greater than nano sized particles. After separation, both slurries may be shipped and sold as is or the greater than nano sized particles slurry may be recycled through either said water supply tank 2 for nonabrasive materials or at 24 for abrasive materials.

In a fourth embodiment, said orifice 64 is not elongated. Instead, a pair of opposed vanes is affixed to the outer surface of said jet 16 such that the material/liquid slurry is forced into the shape of a thin fan upon exiting said orifice 64.

In the preferred embodiment, all elements are conventional and may be secured from a variety of sources with the exception of said jets 16. Said jets 16 are manufactured from an alloy such as AR steel, Ni-hard steel, or a ceramic which is very resistant to abrasion. All elements which transport slurry are also made from abrasion resistant material.

While preferred embodiments of this invention have been shown and described above, it will be apparent to those skilled in the art that various modifications may be made in these embodiments without departing from the spirit of the present invention.

I claim:

1. A hydraulic jet mill for reducing the size of a flake shaped material to nano size or less while maintaining or increasing the aspect ratio of the material where the aspect ratio is the ratio of the average width of a particle of the material to the average thickness of such particle comprising:
(1) a jet having a forward end and a rearward end and having an open orifice at the forward end;
(2) means for introducing a slurry of the material and an incompressible liquid into the jet at a point rearward of the orifice and under sufficient pressure that the slurry exits said orifice at at least ten meters per second; and
(3) an impingement plate located forward of said orifice at a distance of less than one millimeter from said orifice and such that the slurry strikes the impingement plate upon leaving said orifice;
whereby a slurry of a flake shaped material and an incompressible liquid may be introduced into said jet under pressure and the slurry exits said orifice in said plate and strikes said impingement plate and a significant portion of the material is reduced in size to nano sized or less while maintaining or increasing the aspect ratio of the material.

2. The hydraulic jet mill of claim 1 in which said orifice is significantly narrower than it is wide.

3. The hydraulic jet mill of claim 1 in which a pair of opposed vanes are affixed to the forward surface of said jet such that the slurry is forced into the shape of a thin fan upon leaving said orifice.

4. The hydraulic jet mill of claim 1 in which there is a second of said jets which is opposed to the first such that the streams of slurry leaving said orifices of said jets strike each other rather than said impingement plate.

5. The hydraulic jet mill of claim 2 in which there is a second of said jets which is opposed to the first such that the streams of slurry leaving said orifices of said jets strike each other rather than said impingement plate.

6. The hydraulic jet mill of claim 3 in which there is a second of said jets which is opposed to the first such that the streams of slurry leaving said orifices of said jets strike each other rather than said impingement plate.

7. The hydraulic jet mill of claim 1 in which the material in the slurry is classified and separated according to size after hitting said impingement plate and material greater than nano sized is recycled with incompressible liquid through said jet.

8. The hydraulic jet mill of claim 2 in which the material in the slurry is classified and separated according to size after hitting said impingement plate and material greater than nano sized is recycled with incompressible liquid through said jet.

9. The hydraulic jet mill of claim 3 in which the material in the slurry is classified and separated according to size after hitting said impingement plate and material greater than nano sized is recycled with incompressible liquid through said jet.

10. The hydraulic jet mill of claim 4 in which the material in the slurry is classified and separated according to size after the two streams of slurry collide and material greater than nano sized is recycled with incompressible liquid through said jets.

11. The hydraulic jet mill of claim 5 in which the material in the slurry is classified and separated according to size after the two streams of slurry collide and material greater than nano sized is recycled with incompressible liquid through said jets.

12. The hydraulic jet mill of claim 6 in which the material in the slurry is classified and separated according to size after the two streams of slurry collide and material greater than nano sized is recycled with incompressible liquid through said jets.
